(19) United States
(12) Patent Application Publication
(10) Pub. No.: US 2026/0359081 A1
(43) Pub. Date: Nov. 12, 2026

(54) WINDOW GENERATION APPARATUS, CLIENT TERMINAL, WINDOW GENERATION SYSTEM, WINDOW GENERATION METHOD, AND WINDOW GENERATION PROGRAM

(71) Applicant: Internet Initiative Japan Inc., Tokyo (JP)

(72) Inventors: Yuta MIZUTANI, Chiba (JP); Shimpei OGAWA, Tokyo (JP); Kohsuke NAKANISHI, Tokyo (JP)

(21) Appl. No.: 19/663,095

(22) Filed: Apr. 29, 2026

Related U.S. Application Data
(63) Continuation of application No. PCT/JP2024/038424, filed on Oct. 28, 2024.

(51) Int. Cl. G06F 9/451; G06Q 30/018; H04L 67/52

(52) U.S. Cl. CPC G06F 9/451; G06Q 30/018; H04L 67/52

(57) ABSTRACT

A window generation apparatus causes a client terminal to execute a window generation function. The window generation function includes a jurisdiction determination unit that determines, based on a location of a client terminal that accesses a web page, a jurisdiction to which the location of the client terminal belongs, a window generation unit that generates a window corresponding to the jurisdiction, a window display unit that causes the window to be displayed on the client terminal. The window is displayed on a display of the client terminal when a request specifying a URL of a web page is sent from the client terminal to a server. In this manner, determination of the jurisdiction to which the location of the client terminal belongs and display of the window based on legal requirements prescribed by this jurisdiction can be automatically performed.

The contents of the following patent application is incorporated herein by reference:
NO. PCT/JP2024/038424 filed in WO on Oct. 28, 2024.

### BACKGROUND

### 1. Technical Field

The present invention relates to a window generation apparatus, a client terminal, a window generation system, a window generation method, and a window generation program.

### 2. Related Art

An information processing apparatus is known, where a user terminal that requested access to an accessing target domain is caused to display a small screen (which may also be referred to simply as a window), such as a banner, a pop-up window or the like, that covers a part or all of a screen for accepting consent to use cookies related to access to this domain and other linked domains, before the user terminal transitions from the accessing target domain to another linked domain (see Patent Document 1, for example). However, such an information processing apparatus is incapable of causing a screen corresponding to types of consent prescribed by each jurisdiction to be displayed.

### RELATED ART DOCUMENTS

### Patent Documents

Patent Document 1: Japanese Patent Application Publication No. 2023-170155

### BRIEF DESCRIPTION OF THE DRAWINGS

FIG. 1 illustrates a schematic configuration of a window generation system according to the present embodiment.

FIG. 2 illustrates a functional configuration of a window generation apparatus.

FIG. 3 illustrates an example of registration information in a geographical information database.

FIG. 4 illustrates an example of registration information in a jurisdiction database.

FIG. 5 illustrates an example of a window.

FIG. 6 illustrates an example of a window.

FIG. 7 illustrates an example of registration information in a generation rule database.

FIG. 8 illustrates a window generation flow.

FIG. 9 illustrates a display of a client terminal on which an example of a window is displayed.

FIG. 10 illustrates a display of a client terminal on which an example of a window is displayed.

FIG. 11 illustrates a display of a client terminal on which an example of a window is displayed.

FIG. 12 illustrates an example of a configuration of a computer.

### DESCRIPTION OF EXEMPLARY EMBODIMENTS

Embodiments will be described below, but the following embodiments do not limit the scope of the invention. Further, not all of combinations of features described in the embodiments are essential to the solving means of the invention.

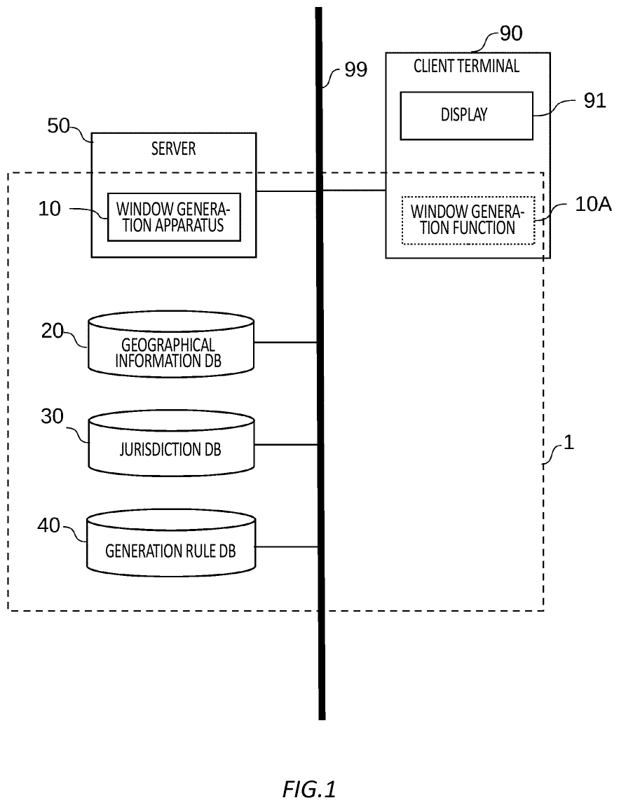

FIG. 1 illustrates a schematic configuration of a window generation system 1 according to the present embodiment. The window generation system 1 (also referred to simply as the system 1) is a network system for generating a window for confirming with a user the confirmation requirement compatible with a jurisdiction to which a location of a client terminal 90 belongs, and causes the window to be displayed on the client terminal 90. The system 1 includes a window generation apparatus 10. The system 1 may further include a geographical information database (geographical information DB) 20, a jurisdiction database (jurisdiction DB) 30, and a generation rule database (generation rule DB) 40. These components are communicatively connected to one another via a network 99. Note that, although a window generation apparatus 10 is illustrated as part of a server 50, some functional units (window generation function 10A) included in the window generation apparatus 10 are sent to a client terminal 90 and executed in the client terminal 90, as described later. The database is also referred to as DB.

Note that, the network 99 is a communication network that communicatively connects the window generation apparatus 10 and various types of databases such as the geographical information database 20 with each other. The network 99 is, as an example, the Internet, but is not limited thereto, and any communication network such as a local area network or a telephone line may be adopted as long as these apparatuses and DBs can communicate with one another, or a network in which a plurality of communication networks are mixed may be adopted.

Note that, the server 50 operates a website accessed by the client terminal 90. The server 50 can include the window generation apparatus 10 described later entirely or partially.

It should be noted that the client terminal 90 is, for example, a terminal apparatus which is used by a user. The terminal apparatus may be a computer terminal such as a personal computer, or a portable terminal such as a smartphone or a tablet computer. The client terminal 90 includes a central processing unit (CPU) and a communication apparatus (neither is shown). The CPU receives a response from the server 50 and executes a window generation program, or a script, included therein, so that the client terminal 90 executes some or all functions of the window generation apparatus 10, namely the window generation function 10A described later. The communication apparatus is an apparatus which can mutually communicate with the server 50 and various types of databases via the network 99 in a wired or wireless manner; and can use a protocol such as TCP/IP for the communication, as an example. The client terminal 90 includes the display 91, such as a liquid crystal display, and functions as a client terminal which communicates with the server 50 to cause a web page or the like to be displayed on the display 91. The system 1 may include a plurality of client terminals 90 respectively possessed by a plurality of users, and the plurality of users can use the system 1.

The window generation apparatus 10 is a computer apparatus that, when a request specifying a URL of a web page is sent from the client terminal 90, determines a location of the client terminal 90, and sends back a response to the client terminal 90 to cause execution of the window generation function 10A. The window generation apparatus 10 includes a central processing unit (CPU) and a communication apparatus (neither is shown). Note that, the window generation apparatus 10 may be implemented by a cloud, for example, a plurality of distributed servers, a plurality of subsystems, or the like. The CPU effects a location determination function by executing a dedicated program when a request is received from the client terminal 90, and effects a function of causing a window to be displayed on the client terminal 90 by sending a response including the window generation program (script) to the client terminal 90 to cause it to execute the window generation program.

A functional configuration of the window generation apparatus 10 will be described later. It should be noted that the dedicated program is, for example, stored in a ROM (not shown) to be read by the CPU; or is stored in a storage medium such as a CD-ROM to be read by the CPU using a reading apparatus (not shown); thereby being activated. The window generation program is read out from a ROM (not shown), or the like, sent to the client terminal 90, and deployed in a RAM, so that it can be activated on the client terminal 90. The window generation program may be a script such as JavaScript (registered trademark), included in a web page. The communication apparatus is an apparatus that can mutually communicate with the server 50, the client terminal 90, and various types of databases via the network 99 in a wired or wireless manner; and can use a protocol such as TCP/IP for the communication, as an example.

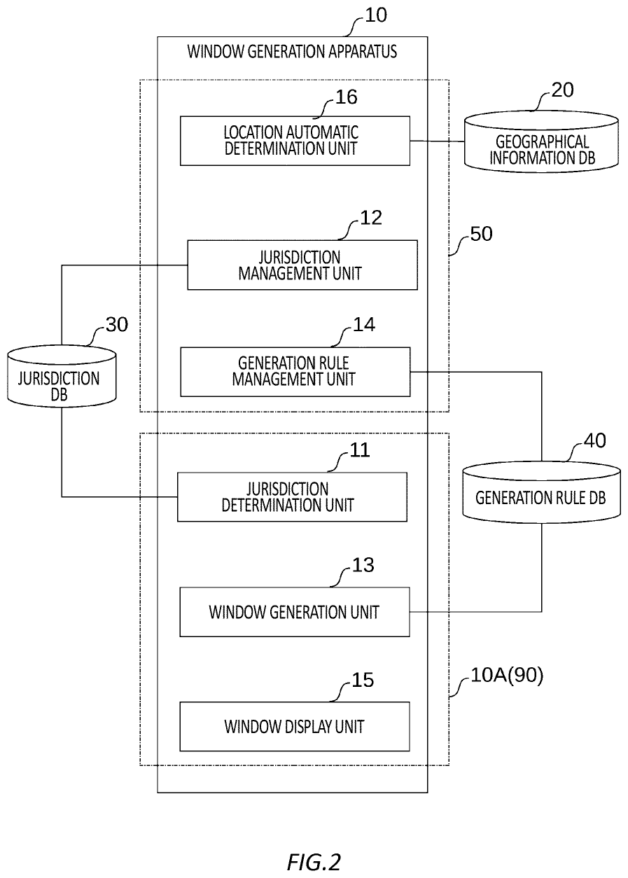

FIG. 2 illustrates the functional configuration of the window generation apparatus 10. The window generation apparatus 10 includes a location automatic determination unit 16, a jurisdiction determination unit 11, a jurisdiction management unit 12, a window generation unit 13, a generation rule management unit 14, and a window display unit 15. Among these functional units, the jurisdiction determination unit 11, the window generation unit 13, and the window display unit 15 are also referred to as the window generation function 10A. The window generation function 10A is sent from the server 50 to the client terminal 90 and executed at the client terminal 90. For example, the window generation function 10A is implemented as a script, embedded in a web page, and sent to the client terminal 90 as part of a response from the server 50. By executing the window generation function 10A on the client terminal 90, it is possible to achieve a load reduction or the like of the server 50. However, it may also be configured such that the window generation function 10A is partially or entirely executed by the window generation apparatus 10 (the server 50), i.e., the window generation function 10A is executed by a plurality of apparatuses, including the window generation apparatus 10 (the server 50) and the client terminal 90.

The location automatic determination unit 16 acquires a network address of the client terminal 90, and determines the location of the client terminal 90 based on the network address. The method of determining the location of the client terminal 90 based on the network address includes, for example, accessing, by the client terminal 90, a website operated by the server 50 and acquiring, by the server 50, the network address (in this case, an IP address) of the client terminal 90. By querying the geographical information database 20 with this network address, the location at the time when the client terminal 90 sent the request to the server 50 can be acquired. According to the location automatic determination unit 16, the location can be automatically determined without waiting for an input by a user, and by inputting this location into the window generation unit 13 to select an appropriate generation rule, a window with appropriate language settings or the like can be generated.

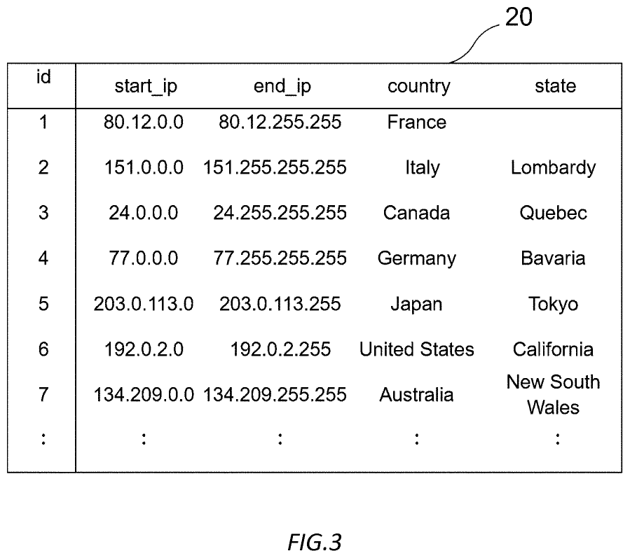

FIG. 3 illustrates an example of registration information in the geographical information database 20. The geographical information database 20 is a database in which a range of network addresses and information associated with positional information are registered, and is used to identify a location of a terminal based on the network address. Each row of a table in the geographical information database 20 associates a particular IP address range (start_ip and end_ip) and information on countries (country) and states/regions (state) with each other. For example, the IP address range from 80.12.0.0 to 80.12.255.255 corresponds to France, and IP addresses from 203.0.113.0 to 203.0.113.255 are associated with Tokyo, Japan. According to the geographical information database 20, the location of the client terminal 90 can be determined based on the network address. For example, the location of the client terminal 90 with the IP address 203.0.113.1 is determined to be Tokyo.

The jurisdiction determination unit 11 is a functional unit that determines a jurisdiction to which the location of the client terminal 90 belongs based on the location of the client terminal 90 that accesses the web page. The jurisdiction herein means a certain region where a particular law is adopted. As an example of a law related to protection of personal data, the European Union (EU) is a jurisdiction where General Data Protection Regulation (GDPR) is adopted. California in the United States is a jurisdiction where California Consumer Privacy Act (CCPA) is adopted. Canada is a jurisdiction where Personal Information Protection and Electronic Documents Act (PIPEDA) is adopted. Criteria of data protection required by these data protection laws are different; for example, requirements of the GDPR prohibit data collection to be performed until the user expresses affirmative consent, while requirements of the CCPA permit data collection as long as a so-called opt-out mechanism, where the user can stop the data collection, is implemented. In this manner, confirmation requirements for access to a website by a user are different in each jurisdiction.

The jurisdiction determination unit 11 determines, as the location of the client terminal 90, the location information input by the user of the client terminal 90 to the location information input interface of the window generated by the window generation unit 13 described later. Executing location determination by the jurisdiction determination unit 11 based on the user input allows a correct location to be acquired through an input by the user, even in a case where the location automatic determination unit 16 could not determine an accurate location or a case where automatic determination of the location has failed for some reason. The jurisdiction determination unit 11 may set an initial value of the location information input interface to a location determined based on the network address of the client terminal. The location automatically determined based on the network address is often accurate, so setting the automatically determined location as the initial value can simplify the user input.

Further, the jurisdiction determination unit 11 determines the jurisdiction to which the location of the client terminal 90 belongs by comparing the location, determined from the network address as described above or input by the user, with the jurisdiction database 30.

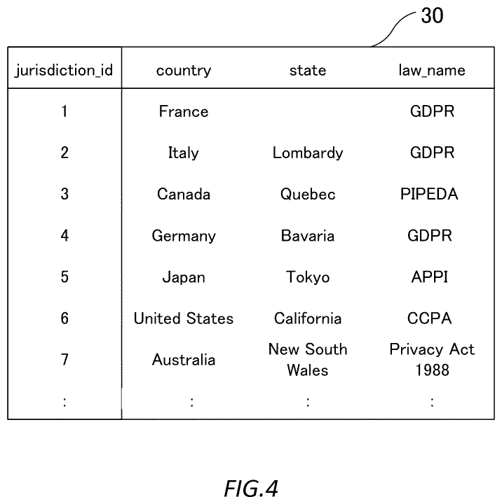

FIG. 4 illustrates an example of registration information in the jurisdiction database 30. The jurisdiction database 30 is a database in which regions and jurisdictions to which the regions belong are registered in association with each other. In the present embodiment, in particular, the jurisdiction database 30 is a database in which data obtained by associating locations of the client terminals 90 and laws adopted at the locations with each other is registered, and is used to identify the jurisdiction to which the location of the client terminal 90 belongs. Each row of a table in the jurisdiction database 30 associates an ID of the jurisdiction (jurisdiction_id), the country (country), the state/region (state), and the main data protection law adopted at the place (law_name) with each other. Note that, the law to be associated is not limited to data protection laws, and may be various laws such as regulations prescribing restrictions on alcohol intake or regulations prescribing restrictions on smoking. The jurisdiction database 30 enables automatically identifying which law is to be adopted at the location. For example, according to registration information on the fifth row, the jurisdiction to which Tokyo belongs is Japan, where the data protection law APPI is adopted.

The jurisdiction management unit 12 manages the jurisdiction database 30 in response to an administrator who operates the window generation apparatus 10 performing an operation via an interface thereof, for example. Management herein includes updating the association relationship between jurisdictions and laws with latest information, adding association relationship with new laws, or the like. For example, when a particular city or the like enforced its own data protection regulation in Japan, this association relationship between the city and the law can be added to the jurisdiction database 30, or the like.

The window generation unit 13 is a functional unit that generates a window corresponding to the jurisdiction, which generates a window (jurisdiction-specific screen) based on a window generation rule in accordance with legal requirements prescribed by the jurisdiction. The legal requirements herein refer to requirements, based on data protection regulations or the like prescribed by each jurisdiction, such as guaranteeing of opt-in or opt-out for a user, age verification, acquiring consent by a parent or guardian, and language to be displayed. The window refers to an age verification screen, a consent confirmation screen or the like through which confirmation can be performed according to such requirements. The window generation rule includes a list of elements such as an input form for obtaining confirmation according to such legal requirements.

The window generation unit 13 acquires, from the generation rule database 40 in which jurisdictions and window generation rules are associated with each other, a window generation rule corresponding to the jurisdiction to which the location of the client terminal 90 belongs, and generates a window based on the acquired window generation rule. Herein, the window generation unit 13 can include a location information input interface in the window based on the window generation rule, for example.

Note that, the window generation unit 13 may generate a window (a jurisdiction identification screen) for accepting a location input or the like by the user before the jurisdiction-specific screen in order to accurately acquire the location of the client terminal 90 and thereby determine the jurisdiction to which it belongs. The window generation unit 13 includes a location input unit in the jurisdiction identification screen. The window generation unit 13 may include an input of age verification or the like in the jurisdiction identification screen, and may manage a language to be displayed, a list of input units or the like with the window generation rule (not shown).

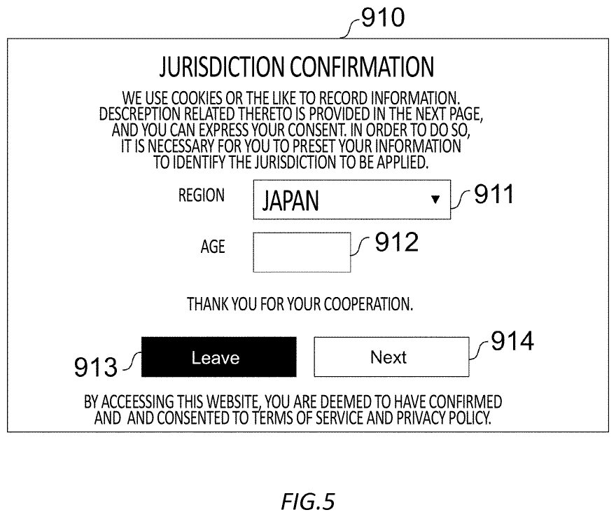

FIG. 5 illustrates an example of the window (jurisdiction identification screen). The window 910 is a small screen such as a pop-up window that is displayed on the display 91 of the client terminal 90 to acquire the location or the like of the client terminal 90 and determine the jurisdiction to which it belongs, and includes, as examples, a location input unit 911, an age input unit 912, a withdrawal button 913, and a registration button 914. In this example, the client terminal 90 is located within Japan, and the jurisdiction determination unit 11 determines the location to be Japan from its network address and sets the initial value of the location input unit 911 to Japan.

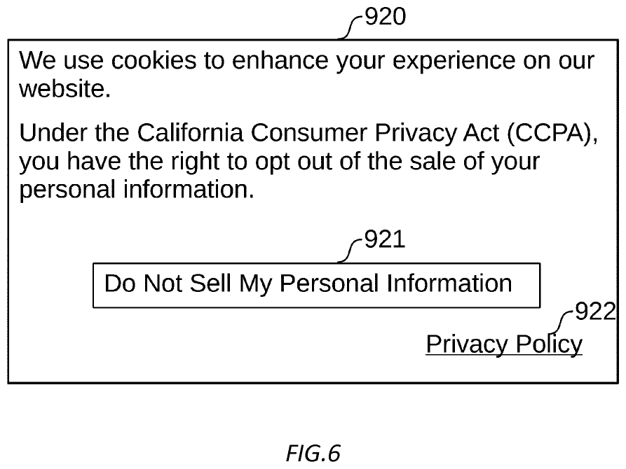

FIG. 6 illustrates an example of the window (jurisdiction-specific screen). The window 920 is a small screen such as a pop-up window displayed on the display 91 of the client terminal 90 for confirming whether or not use of personal information by the website is permitted when the jurisdiction to which the client terminal 90 belongs is determined by the jurisdiction determination unit 11, based on inputs to the location input unit 911 and the age input unit 912 in the window 910 (FIG. 5), and includes, as examples, an opt-out button 921, a privacy policy confirmation link 922. In this example, since “United States (California)” is input to the location input unit 911 in FIG. 5 and “age 20” is input to the age input unit 912, the opt-out button 921, which is required by the CCPA adopted in the jurisdiction of California, is displayed. Note that, in the CCPA, since affirmative consent (opt-in) by a parent or guardian is required for use of data relating to users under the age of 13 while their own opt-in is required for use of data relating to users aged 13 to 16, the window to be displayed is different depending on the age of the user, such an age condition does not exist in the APPI adopted in Japan. In this manner, the window to be displayed varies depending on the jurisdiction and by age.

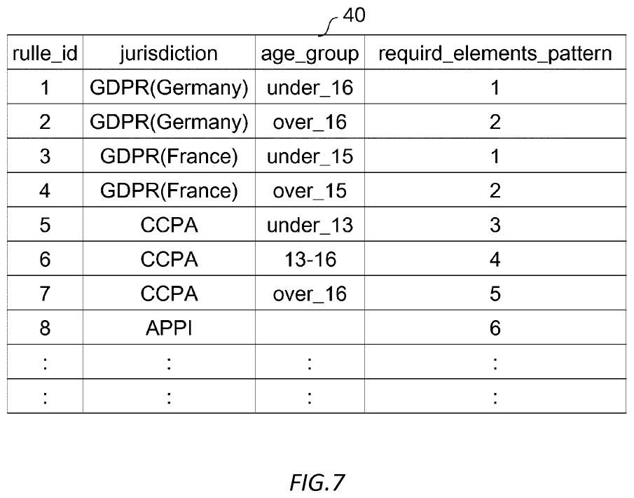

FIG. 7 illustrates an example of registration information in the generation rule database 40. The generation rule database 40 is a database in which data obtained by associating jurisdictions and items to be set in the window based on legal requirements prescribed by the jurisdictions with each other are registered. Columns in the table indicate, from the left, a rule ID, a jurisdiction, an age category, a set pattern ID of a required screen element. The screen element is, for example, an opt-in input element for the user to indicate affirmative consent (opt-in) of their own will, a description or the like. The generation rule database 40 may include other related items, for example, the language used or the like. For example, according to the registration information in the seventh row, being under the California Consumer Privacy Act and the age input by the user exceeding the age of 16 is associated with the screen element set 5 that constitutes the jurisdiction-specific screen (window 920 in FIG. 6) having an opt-out function and a description part.

The generation rule management unit 14 manages, for example, in response to operations being performed by an administrator who operates the window generation apparatus 10 via its interface, the generation rule database 40 by registering, updating, and deleting window generation rules based on the laws in each jurisdiction. In this manner, the window generation unit 13 is enabled to appropriately generate an UI element that is suitable for each jurisdiction. For example, if the Act on the Protection of Personal Information (APPI), which is adopted in Japan, is revised so that opt-in is required for companies, an input form of an opt-in type can be registered in association with Japan.

The window display unit 15 is a functional unit that causes the window to be displayed on the client terminal 90, and the window is displayed on the display 91 of the client terminal 90 when a request specifying a URL of a web page is sent from the client terminal 90 to the server 50. The window may be a screen that is displayed before transition to a web page of a website that the client terminal 90 attempts to access, a banner that disables operation on the web page and covers a part or all of the web page, or a small screen such as a pop-up window.

The window generation function 10A, which is caused to be executed by the client terminal 90 by the window generation apparatus 10 according to the present embodiment, includes the jurisdiction determination unit 11, the window generation unit 13, and the window display unit 15. The jurisdiction determination unit 11 determines, based on the location of the client terminal 90 that accesses the web page, the jurisdiction to which the location of the client terminal 90 belongs (that is, a jurisdiction determination function performed by the jurisdiction determination unit 11), the window generation unit 13 generates a window corresponding to the jurisdiction (that is, a jurisdiction-specific window generation function performed by the window generation unit 13), and the window display unit 15 causes the window to be displayed on the client terminal 90 (that is, a window display function performed by the window display unit 15). The window is displayed on the display 91 of the client terminal 90 when a request specifying a URL of a web page is sent from the client terminal 90 to the server 50. In this manner, determination of the jurisdiction to which the location of the client terminal 90 belongs and display of the window based on legal requirements prescribed by this jurisdiction can be automatically performed.

Note that, causing the client terminal 90 to execute the window generation function 10A can be understood as executing the window generation program by the client terminal 90 to cause the jurisdiction determination function of the jurisdiction determination unit 11, the jurisdiction-specific window generation function of the window generation unit 13, and the window display function of the window display unit 15 to be executed, or executing the window generation program by the client terminal 90 to cause the jurisdiction determination unit 11, the window generation unit 13, and the window display unit 15 to be implemented in the client terminal 90 to cause the jurisdiction determination function, the jurisdiction-specific window generation function, and the window display function to be effected.

Note that, in response to an operation of accessing a web page being performed on the client terminal 90 by the user, a request specifying a URL of the web page is sent from the client terminal 90 to the server 50, the server 50 sends back a response to the client terminal 90, and the client terminal 90 executes the window generation program (script) included in the response; thereby a part or all of the functions of the window generation apparatus 10 may be implemented by the client terminal 90. Thus, the client terminal includes a jurisdiction determination unit 11 that determines, based on the location of the client terminal 90 that accesses the web page, the jurisdiction to which the location of the client terminal 90 belongs, the window generation unit 13 that generates the windows 910, 920 corresponding to the jurisdiction, and the window display unit 15 that causes the windows 910, 920 to be displayed on the client terminal 90. Herein, the windows 910, 920 are displayed on the display 91 of the client terminal 90 when the request specifying the URL of the web page is sent from the client terminal 90 to the server 50.

The window generation system 1 according to the present embodiment includes the window generation apparatus 10, and the client terminal 90 that executes the window generation function by receiving, from the window generation apparatus 10 (the server 50), a window generation program and/or a response including a window generation program, and executing the window generation program. The window generation system 1 further includes the generation rule database 40 in which jurisdictions and window generation rules are associated with each other, and the window generation apparatus 10 generates the window based on a window generation rule retrieved from the generation rule database 40, the window generation rule corresponding to the jurisdiction to which the location of the client terminal 90 belongs and being in accordance with legal requirements prescribed by the jurisdiction.

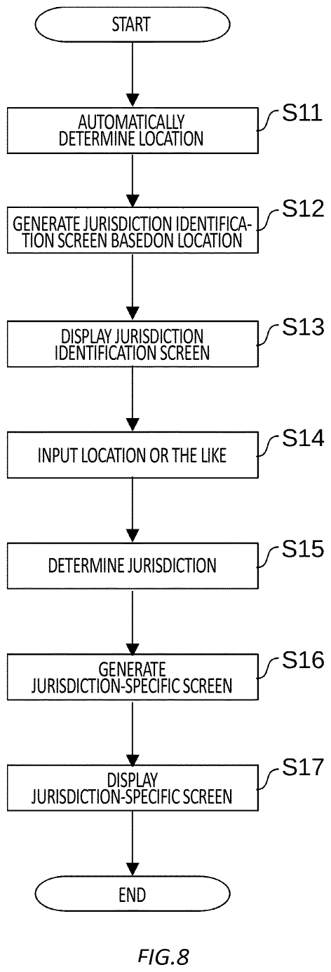

FIG. 8 illustrates a window generation flow that is executed by the window generation apparatus 10. The window generation flow is started by, in response to an operation of accessing the web page being performed on the client terminal 90 by the user, a request specifying the URL of the web page being sent from the client terminal 90 to the server 50, the server 50 sending back a response to the client terminal 90, and the client terminal 90 executing a script, that is, the window generation function, included in the response.

At step S11, the window generation apparatus 10 (location automatic determination unit 16) determines the location of the client terminal 90 that accesses the web page, based on the network address of the client terminal 90. Details of the determination based on the network address are as described above. For example, an assumption is made that it is determined to be “Japan”, based on the network address.

At step S12, the window generation apparatus 10 (window generation unit 13) generates a jurisdiction identification screen (the window 910 in FIG. 5). Details of the generation are as described above. The window 910 is a window for acquiring information required to determine the jurisdiction, such as a correct location, from an input by the user, and includes the location input unit 911. As a location automatically determined by the location automatic determination unit 16, in the example of the window 910 shown in FIG. 5, “Japan” is input to the location input unit 911 as the initial value. Although it is possible to determine the location based on the network address without generating the window 910, to determine the jurisdiction, a more accurate location can be acquired according to the window 910. In addition, by including the age input unit 912 in the window 910, when confirmation items required by law are different depending on the user's age, a corresponding jurisdiction-specific screen (the window 920 in FIG. 6) can be generated.

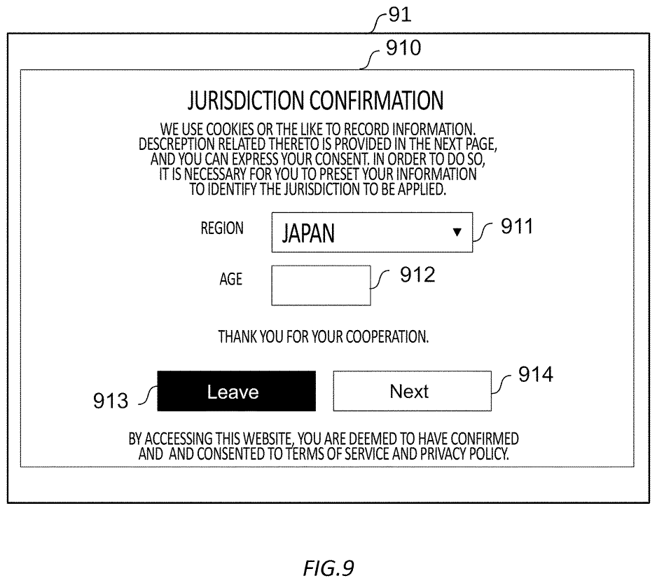

At step S13, the window generation apparatus 10 (window display unit 15) causes the window 910 to be displayed on the client terminal 90, i.e., causes the window 910 to be output to the display 91 of the client terminal 90. FIG. 9 illustrates the display 91 of the client terminal 90 on which an initial screen of the window 910 is displayed.

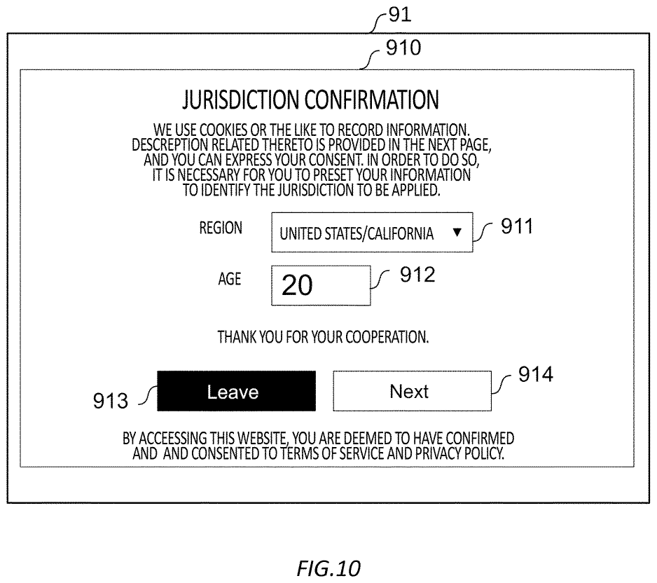

At step S14, the user inputs the location or the like to the location input unit 911 of the window 910. Herein, an assumption is made that the user has selected “United States (California)” as the region and has input “20” as the age. Thus, as illustrated in FIG. 10, the window 910 showing “United States (California)” as the selected region and “20” as the input age is displayed on the display 91 of the client terminal 90.

At step S15, the window generation apparatus 10 (jurisdiction determination unit 11) determines, from the location input to the location input unit 911, the jurisdiction to which the location of the client terminal 90 belongs. Details of the determination are as described above. In the example of the window 910 illustrated in FIG. 10, the jurisdiction “California” and the law “California Consumer Privacy Act (CCPA)” corresponding to the jurisdiction are selected from the “United States (California)” input to the location input unit 911.

At step S16, the window generation apparatus 10 (window generation unit 13) generates the jurisdiction-specific screen (the window 920 in FIG. 6) based on the window generation rule corresponding to the jurisdiction determined at step S15. That is, since the client terminal 90 exists under the CCPA that corresponds to the jurisdiction “California” and the age of the user is over 16, a screen element set (required_elements_pattern) 5 of the window generation rule on the seventh row in the generation rule database 40 (see FIG. 7) is acquired, and the window 920 including the screen elements included in this screen element set is generated. Details of the generation are as described above.

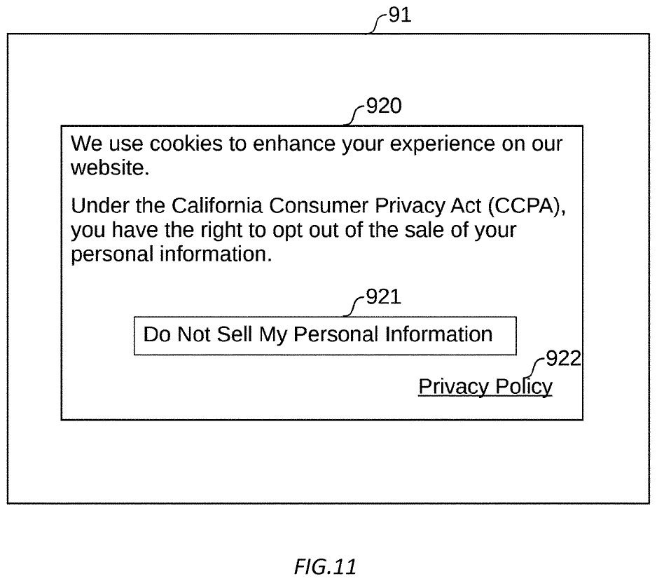

At step S17, the window generation apparatus 10 (window display unit 15) causes the window 920 to be displayed on the client terminal 90, i.e., causes the window 920 to be output to the display 91 of the client terminal 90. FIG. 11 illustrates the display 91 of the client terminal 90 on which the window 920 is displayed. In this manner, by sending the request in which the URL of the web page is specified from the client terminal 90 to the server 50, a series of flow is executed to cause the window 920 to be displayed on the display 91 of the client terminal 90.

The window generation method executed by one or more computers according to the present embodiment includes determining, based on a location of a client terminal 90 that accesses a web page, a jurisdiction to which the location of the client terminal 90 belongs, generating a window corresponding to the jurisdiction, and causing the window to be displayed on the client terminal 90, wherein the window is displayed on the display 91 of the client terminal 90 when the request specifying a URL of the web page is sent from the client terminal 90 to the server 50. In this manner, determination of the jurisdiction to which the location of the client terminal 90 belongs and display of the window based on legal requirements prescribed by this jurisdiction can be automatically performed.

Various embodiments of the present invention may be described with reference to flowcharts and block diagrams whose blocks may represent (1) steps of processes in which operations are performed or (2) sections of apparatuses responsible for performing operations. Certain stages and sections may be implemented by a dedicated circuit, a programmable circuit supplied together with computer-readable instructions stored on computer-readable media, and/or processors supplied together with computer-readable instructions stored on computer-readable media. The dedicated circuit may include digital and/or analog hardware circuits, and may include integrated circuits (IC) and/or discrete circuits. The programmable circuit may include a reconfigurable hardware circuit including logical AND, logical OR, logical XOR, logical NAND, logical NOR, and other logical operations, a memory element or the like such as a flip-flop, a register, a field programmable gate array (FPGA) and a programmable logic array (PLA), or the like.

A computer-readable medium may include any tangible device that can store instructions to be executed by a suitable device, and as a result, the computer-readable medium having instructions stored thereon includes a product including instructions that can be executed in order to create means for executing operations designated in the flowcharts or block diagrams. Examples of the computer-readable medium may include an electronic storage medium, a magnetic storage medium, an optical storage medium, an electromagnetic storage medium, a semiconductor storage medium, and the like. More specific examples of the computer-readable medium may include a floppy (registered trademark) disk, a diskette, a hard disk, a random-access memory (RAM), a read-only memory (ROM), an erasable programmable read-only memory (EPROM or flash memory), an electrically erasable programmable read-only memory (EEPROM), a static random access memory (SRAM), a compact disk read-only memory (CD-ROM), a digital versatile disk (DVD), a Blu-ray (registered trademark) disk, a memory stick, an integrated circuit card, and the like.

The computer-readable instruction may include: an assembler instruction, an instruction-set-architecture (ISA) instruction; a machine instruction; a machine dependent instruction; a microcode; a firmware instruction; state-setting data; or either a source code or an object code described in any combination of one or more programming languages, including an object oriented programming language such as Smalltalk (registered trademark), JAVA (registered trademark), C++, or the like, and a conventional procedural programming language such as a “C” programming language or a similar programming language.

The computer-readable instruction may be provided for a processor or a programmable circuit of a programmable data processing apparatus, such as a computer, locally or via a local area network (LAN), a wide area network (WAN) such as the Internet, or the like to execute the computer-readable instruction in order to create means for executing the operations specified in the flowcharts or block diagrams. Here, the computer may be a personal computer, or PC, a tablet computer, a smartphone, a workstation, a server computer, a general-purpose computer, a special-purpose computer, or the like, or may be a computer system to which a plurality of computers are connected. Such computer system to which the plurality of computers are connected is also referred to as a distributed computing system, and is a computer in a broad sense. In a distributed computing system, a plurality of computers collectively execute a program by each of the plurality of computers executing a portion of the program, and passing data during the execution of the program among the computers as needed.

Examples of the processor include a computer processor, a central processing unit (CPU), a processing unit, a microprocessor, a digital signal processor, a controller, a microcontroller, and the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multiple tasks, each of the plurality of processors may execute a portion of each task pieces by pieces by performing task-switching for each time slice. In this case, which portion of one program each processor is responsible for executing dynamically changes. Moreover, which portion of the program each of the plurality of processor is responsible for executing may be determined statically by multiprocessor-aware programming.

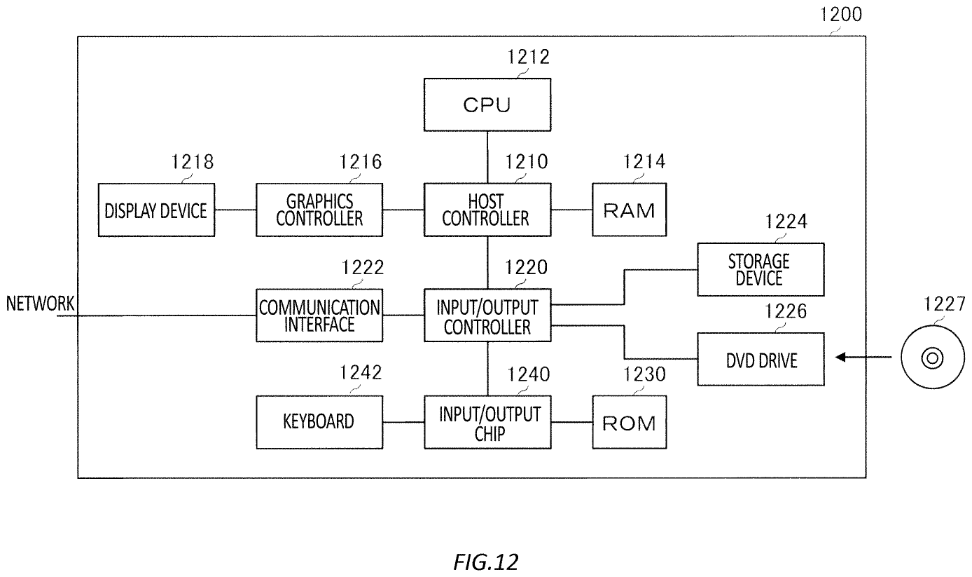

FIG. 12 illustrates an example of a computer 1200 in which a plurality of aspects of the present invention may be embodied entirely or partially. A program that is installed in the computer 1200 can cause the computer 1200 to function as an operation associated with an apparatus according to embodiments of the present invention or one or more “sections” in the apparatus, or cause the computer 1200 to perform the operation or the one or more sections thereof, and/or cause the computer 1200 to perform processes according to the embodiment of the present invention or steps thereof. Such a program may be performed by a CPU 1212 so as to cause the computer 1200 to perform certain operations associated with some or all of the blocks of flowcharts and block diagrams described herein.

The computer 1200 in accordance with the present embodiment includes a CPU 1212, a RAM 1214, a graphics controller 1216, and a display device 1218, which are mutually connected by a host controller 1210. The computer 1200 also includes a storage device 1224 such as a communication interface 1222, a hard disk drive, or the like, an input/output unit such as a DVD-ROM drive 1226 and the IC card drive, which are connected to a host controller 1210 via an input/output controller 1220. The computer also includes legacy input/output units such as an ROM 1230 and a keyboard 1242, which are connected to the input/output controller 1220 via an input/output chip 1240.

The CPU 1212 operates according to programs stored in the ROM 1230 and the RAM 1214, thereby controlling each unit. The graphics controller 1216 acquires image data generated by the CPU 1212 on a frame buffer or the like provided in the RAM 1214 or in itself, and causes the image data to be displayed on a display device 1218.

The communication interface 1222 communicates with other electronic devices via a network. The storage device 1224 stores the program and data used by the CPU 1212 within the computer 1200. The DVD-ROM drive 1226 reads the program or data from the DVD-ROM 1227 and provides the program or data to the storage device 1224 via the RAM 1214. The IC card drive reads the programs and the data from the IC card, and/or writes the programs and the data to the IC card.

The ROM 1230 stores therein a boot program or the like that is performed by the computer 1200 at the time of activation, and/or a program depending on the hardware of the computer 1200. The input/output chip 1240 may also connect various input/output units to the input/output controller 1220 via a parallel port, a serial port, a keyboard port, a mouse port, or the like.

Programs are provided by a computer-readable medium such as the DVD-ROM 1227 or the IC card. The program is read from the computer-readable medium, is installed on a storage device 1224, a RAM 1214, or a ROM 1230, which are an example of a computer-readable medium, and is executed by the CPU 1212. Information processing written in these programs is read by the computer 1200, and provides cooperation between the programs and the various types of hardware resources described above. An apparatus or method may be constituted by realizing the operation or processing of information in accordance with the usage of the computer 1200.

For example, when communication is performed between the computer 1200 and an external device, the CPU 1212 may perform a communication program loaded onto the RAM 1214 to instruct communication processing to the communication interface 1222, based on the processing described in the communication program. The communication interface 1222 reads the transmission data stored in a transmission buffer processing region provided on a recording medium such as a RAM 1214, a storage device 1224, a DVD-ROM 1227, or an IC card under the control of a CPU 1212, transmits the read transmission data to the network, or writes the reception data received from the network to a reception buffer processing region or the like provided on a recording medium.

In addition, the CPU 1212 may cause the RAM 1214 to read all or a necessary portion of a file or database stored in an external recording medium such as the storage device 1224, the DVD-ROM drive 1226, or the DVD-ROM 1227, the IC card, or the like, and may execute various types of processes on data on the RAM 1214. The CPU 1212 may then write back the processed data to the external recording medium.

Various types of information such as various types of programs, data, tables, and databases may be stored in a recording medium and subjected to information processing. The CPU 1212 may perform various types of processing on the data read from the RAM 1214, which includes various types of operations, information processing, condition judging, conditional branch, unconditional branch, search/replace of information, etc., as described throughout this disclosure and designated by an instruction sequence of programs, and writes the result back to the RAM 1214. In addition, the CPU 1212 may search for information in a file, a database, or the like in the recording medium. For example, when a plurality of entries, each having an attribute value of a first attribute associated with an attribute value of a second attribute, are stored in the recording medium, the CPU 1212 may search, from the plurality of entries, for an entry with the attribute value of the first attribute specified that meets a condition, read the attribute value of the second attribute stored in said entry, and thereby acquiring the attribute value of the second attribute associated with the first attribute satisfying a predefined condition.

The above-explained program or software modules may be stored in the computer-readable media on or near the computer 1200. In addition, a recording medium such as a hard disk or a RAM provided in a server system connected to a dedicated communication network or the Internet can be used as the computer-readable media, thereby providing the program to the computer 1200 via the network.

While the embodiments of the present invention have been described, the technical scope of the present invention is not limited to the above-described embodiments. It is apparent to persons skilled in the art that various alterations or improvements can be added to the above-described embodiments. It is also apparent from the described scope of the claims that the embodiments added with such alterations or improvements can be included the technical scope of the present invention.

Note that the operations, procedures, steps, stages, or the like of each process performed by a device, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### Other Possible claims

### (Item 1)

A window generation apparatus that, when a request in which a URL of a web page is specified is sent from a client terminal, sends back a response to the client terminal to cause execution of a window generation function, comprising:
a location automatic determination unit that determines a location of the client terminal when the request is sent, wherein
the window generation function includes:
a jurisdiction determination unit that determines a jurisdiction to which the location of the client terminal belongs based on a location of a client terminal that is accessing a web page;
a window generation unit that generates a window corresponding to the jurisdiction; and
a window display unit that causes the window to be displayed on the client terminal, wherein the window is displayed on a display of the client terminal when a request in which a URL of the web page is specified is sent from the client terminal to a server.

### (Item 2)

The window generation apparatus according to item 1, wherein the window generation unit generates the window based on a window generation rule in accordance with legal requirements prescribed by the jurisdiction.

### (Item 3)

The window generation apparatus according to item 2, wherein the window generation unit acquires, from a generation rule database in which jurisdictions and window generation rules are associated with each other, the window generation rule that corresponds to a jurisdiction to which the location of the client terminal belongs.

### (Item 4)

The window generation apparatus according to item 1, wherein the jurisdiction determination unit acquires a network address of the client terminal, and determines the location of the client terminal based on the network address.

### (Item 5)

The window generation apparatus according to item 2, wherein
the window generation unit includes a location information input interface in the window based on the window generation rule, and
the jurisdiction determination unit determines the location of the client terminal based on location information input to the location information input interface by a user of the client terminal.

### (Item 6)

The window generation apparatus according to item 5, wherein an initial value of the location information input interface is a location determined based on a network address of the client terminal.

### (Item 7)

The window generation apparatus according to item 1, wherein
the jurisdiction determination unit determines a jurisdiction to which the location belongs by collating the location with a jurisdiction database, and
the jurisdiction database is a database in which regions and jurisdictions to which the regions belong are registered in association with each other.

### (Item 8)

The window generation apparatus according to item 7, further comprising a jurisdiction management unit that manages the jurisdiction database.

### (Item 9)

The window generation apparatus according to item 3, further comprising a generation rule management unit that manages the generation rule database.

### (Item 10)

A client terminal that implements a window generation function, comprising:
a jurisdiction determination unit that determines, based on a location of a client terminal that is accessing a web page, a jurisdiction to which the location of the client terminal belongs;
a window generation unit that generates a window corresponding to the jurisdiction; and
a window display unit that causes the window to be displayed on the client terminal, wherein the window is displayed on a display of the client terminal when a request in which a URL of the web page is specified is sent from the client terminal to a server.

### (Item 11)

A window generation system comprising:
the window generation apparatus according to any one of items 1 to 9; and
the client terminal according to item 10 that executes the window generation function by receiving and executing a window generation program from the window generation apparatus.

### (Item 12)

The window generation system according to item 11, further comprising:
a generation rule database in which jurisdictions and window generation rules are associated with each other,
wherein the window generation apparatus generates, from the generation rule database, the window based on the window generation rule that corresponds to a jurisdiction to which the location of the client terminal belongs and that is in accordance with legal requirements prescribed by the jurisdiction.

### (Item 13)

A window generation method executed by one or more computers, comprising:
determining, based on a location of a client terminal that is accessing a web page, a jurisdiction to which the location of the client terminal belongs;
generating a window corresponding to the jurisdiction; and
causing the window to be displayed on the client terminal, wherein the window is displayed on a display of the client terminal when a request in which a URL of the web page is specified is sent from the client terminal to a server.

### (Item 14)

The window generation method according to item 13, wherein in the generating, the window is generated based on a window generation rule in accordance with legal requirements prescribed by the jurisdiction.

### (Item 15)

The window generation method according to item 14, wherein in the generating, the window generation rule corresponding to a jurisdiction to which the location of the client terminal belongs is acquired from a generation rule database in which jurisdictions and window generation rules are associated with each other.

### (Item 16)

The window generation method according to item 13, wherein in the determining, a network address of the client terminal is acquired, and the location of the client terminal is determined based on the network address.

### (Item 17)

The window generation method according to item 14, wherein
in the generating, a location information input interface is included in the window based on the window generation rule,
the method further comprising determining the location of the client terminal based on location information input to the location information input interface by a user of the client terminal.

### (Item 18)

The window generation method according to item 17, wherein an initial value of the location information input interface is a location determined based on a network address of the client terminal.

### (Item 19)

The window generation method according to item 13, wherein
in the determining, a jurisdiction to which the location belongs is determined by collating the location with a jurisdiction database, and
the jurisdiction database is a database in which regions and jurisdictions to which the regions belong are registered in association with each other.

### (Item 20)

A window generation program that causes one or more computers to execute the window generation method according to any one of items 13 to 19.

### (Item 21)

A window generation system comprising:
a window generation apparatus that, in response to receiving a request in which a URL of a web page is specified sent from a client terminal, determines the location of the client terminal and sends back a response to the client terminal; and
a client terminal that receives the response from the window generation apparatus and executes a window generation function by executing a window generation program included in the response,
wherein the window generation function includes a jurisdiction determination function that determines, based on the location of the client terminal that is accessing the web page, a jurisdiction to which the location of the client terminal belongs, a jurisdiction-specific window generation function that generates a window corresponding to the jurisdiction, and a window display function that causes the window to be displayed on the client terminal, wherein the window is displayed on a display of the client terminal when a request in which a URL of the web page is specified is sent from the client terminal to a server.

### (Item 22)

The window generation system according to item 21, wherein according to the window generation function, the window is generated based on a window generation rule in accordance with legal requirements prescribed by the jurisdiction.

### (Item 23)

The window generation system according to item 22, wherein according to the window generation function, the window generation rule corresponding to a jurisdiction to which the location of the client terminal belongs is acquired from a generation rule database in which jurisdictions and window generation rules are associated with each other.

### (Item 24)

The window generation system according to item 21, wherein according to the jurisdiction determination function, a network address of the client terminal is acquired, and the location of the client terminal is determined based on the network address.

### (Item 25)

The window generation system according to item 22, wherein according to the window generation function, a location information input interface is included in the window based on the window generation rule, and
according to the jurisdiction determination function, the location of the client terminal is determined based on location information input to the location information input interface by a user of the client terminal.

### (Item 26)

The window generation system according to item 25, wherein an initial value of the location information input interface is a location determined based on the network address of the client terminal.

### (Item 27)

The window generation system according to item 21, wherein according to the jurisdiction determination function, a jurisdiction to which the location belongs is determined by collating the location with a jurisdiction database, and
the jurisdiction database is a database in which regions and jurisdictions to which the regions belong are registered in association with each other.

### (Item 28)

The window generation system according to item 21, further comprising a generation rule database in which jurisdictions and window generation rules are associated with each other,
wherein the window generation apparatus generates, from the generation rule database, the window based on the window generation rule that corresponds to a jurisdiction to which the location of the client terminal belongs and that is in accordance with legal requirements prescribed by the jurisdiction.

### (Item 29)

A window generation method comprising:
in response to receiving a request in which a URL of a web page is specified sent from a client terminal, determining, by a window generation apparatus, a location of the client terminal and sending back a response to the client terminal;
receiving, by the client terminal, the response from the window generation apparatus and executing a window generation function by executing a window generation program included in the response,
wherein the window generation function includes a jurisdiction determination function that determines, based on the location of the client terminal that is accessing the web page, a jurisdiction to which the location of the client terminal belongs, a jurisdiction-specific window generation function that generates a window corresponding to the jurisdiction, and a window display function that causes the window to be displayed on the client terminal, wherein the window is displayed on a display of the client terminal when a request in which a URL of the web page is specified is sent from the client terminal to a server.

### (Item 30)

A program that causes a computer to execute, in response to receiving a request in which a URL of a web page is specified sent from a client terminal, a procedure of determining the location of the client terminal and a procedure of sending back a response to the client terminal and executing a window generation function, wherein
the window generation function includes a jurisdiction determination function that determines, based on the location of the client terminal that is accessing the web page, a jurisdiction to which the location of the client terminal belongs, a jurisdiction-specific window generation function that generates a window corresponding to the jurisdiction, and a window display function that causes the window to be displayed on the client terminal, wherein the window is displayed on a display of the client terminal when a request in which a URL of the web page is specified is sent from the client terminal to a server.

### (Item 31)

A window generation program that causes the computer to execute a procedure of determining, based on a location of a client terminal that is accessing a web page, a jurisdiction to which the location of the client terminal belongs;
a procedure of generating a window corresponding to the jurisdiction; and
a procedure of causing the window to be displayed on the client terminal, wherein the window is displayed on a display of the client terminal when a request in which a URL of the web page is specified is sent from the client terminal to a server.

### EXPLANATION OF REFERENCES

1: window generation system (system); 10: window generation apparatus; 10A: window generation function; 11: jurisdiction determination unit; 12: jurisdiction management unit; 13: window generation unit; 14: generation rule management unit; 15: window display unit; 16: location automatic determination unit; 20: geographical information database; 30: jurisdiction database; 40: generation rule database; 50: server; 90: client terminal; 91: display; 99: network; 910, 920: window; 911: location input unit; 912: age input unit; 913: withdrawal button; 914: registration button; 921: opt-out button; 922: privacy policy confirmation link; 1200: computer; 1210: host controller; 1212: CPU; 1214: RAM; 1216: graphics controller; 1218: display device; 1220: input/output controller; 1222: communication interface; 1224: storage device; 1226: DVD-ROM drive; 1227: DVD-ROM; 1240: input/output chip; 1242: keyboard.

What is claimed is:

1. A window generation apparatus that, when a request specifying a URL of a web page is sent from a client terminal, sends back a response to the client terminal to cause execution of a window generation function, comprising:
a location automatic determination unit that determines a location of the client terminal when the request is sent, wherein the window generation function executed by the client terminal includes:
a jurisdiction determination unit that determines a jurisdiction to which the location of the client terminal belongs based on a location of the client terminal that accesses a web page;
a window generation unit that generates a window corresponding to the jurisdiction; and
a window display unit that causes the window to be displayed on the client terminal, wherein the window is displayed on a display of the client terminal when a request specifying a URL of the web page is sent from the client terminal to a server.

2. The window generation apparatus according to claim 1, wherein the window generation unit generates the window based on a window generation rule in accordance with legal requirements prescribed by the jurisdiction.

3. The window generation apparatus according to claim 2, wherein the window generation unit acquires, from a generation rule database in which jurisdictions and window generation rules are associated with each other, the window generation rule that corresponds to a jurisdiction to which the location of the client terminal belongs, and
the window generation rule includes a set of screen elements.

4. The window generation apparatus according to claim 1, wherein the jurisdiction determination unit acquires a network address of the client terminal, and determines the location of the client terminal based on the network address.

5. The window generation apparatus according to claim 2, wherein
the window generation unit includes a location information input interface in the window based on the window generation rule, and
the jurisdiction determination unit determines the location of the client terminal based on location information that is input to the location information input interface by a user of the client terminal.

6. The window generation apparatus according to claim 5, wherein an initial value of the location information input interface is a location determined based on a network address of the client terminal.

7. The window generation apparatus according to claim 1, wherein
the jurisdiction determination unit determines a jurisdiction to which the location belongs by comparing the location with a jurisdiction database, and
the jurisdiction database is a database in which regions and jurisdictions to which the regions belong are registered in association with each other.

8. The window generation apparatus according to claim 7, further comprising a jurisdiction management unit that manages the jurisdiction database.

9. The window generation apparatus according to claim 3, further comprising a generation rule management unit that manages the generation rule database.

10. A client terminal that implements a window generation function, comprising:
a jurisdiction determination unit that determines, based on a location of the client terminal that accesses a web page, a jurisdiction to which the location of the client terminal belongs;
a window generation unit that generates a window corresponding to the jurisdiction; and
a window display unit that causes the window to be displayed on the client terminal, wherein the window is displayed on a display of the client terminal when a request specifying a URL of the web page is sent from the client terminal to a server.

11. A window generation system comprising:
the window generation apparatus according to claim 1; and
a client terminal comprising:
a jurisdiction determination unit that determines, based on a location of the client terminal that accesses a web page, a jurisdiction to which the location of the client terminal belongs;
a window generation unit that generates a window corresponding to the jurisdiction; and
a window display unit that causes the window to be displayed on the client terminal, wherein the window is displayed on a display of the client terminal when a request specifying a URL of the web page is sent from the client terminal to a server,
wherein the client terminal executes the window generation function by receiving and executing a window generation program from the window generation apparatus.

12. The window generation system according to claim 11, further comprising:
a generation rule database in which jurisdictions and window generation rules are associated with each other,
wherein the window generation apparatus generates, from the generation rule database, the window based on the window generation rule that corresponds to a jurisdiction to which the location of the client terminal belongs and that is in accordance with legal requirements prescribed by the jurisdiction.

13. A window generation method executed by a client terminal, comprising:
determining, based on a location of a client terminal that accesses a web page, a jurisdiction to which the location of the client terminal belongs;
generating a window corresponding to the jurisdiction; and
causing the window to be displayed on the client terminal, wherein the window is displayed on a display of the client terminal when a request specifying a URL of the web page is sent from the client terminal to a server.

14. The window generation method according to claim 13, wherein in the generating, the window is generated based on a window generation rule in accordance with legal requirements prescribed by the jurisdiction.

15. The window generation method according to claim 14, wherein
in the generating, the window generation rule corresponding to a jurisdiction to which the location of the client terminal belongs is acquired from a generation rule database in which jurisdictions and window generation rules are associated with each other,
and wherein the window generation rules include a set of screen elements.

16. The window generation method according to claim 13, wherein in the determining, a network address of the client terminal is acquired, and the location of the client terminal is determined based on the network address.

17. The window generation method according to claim 14, wherein
in the generating, a location information input interface is included in the window based on the window generation rule,
the method further comprising determining the location of the client terminal based on location information that is input to the location information input interface by a user of the client terminal.

18. The window generation method according to claim 17, wherein an initial value of the location information input interface is a location determined based on a network address of the client terminal.

19. The window generation method according to claim 13, wherein
in the determining, a jurisdiction to which the location belongs is determined by comparing the location with a jurisdiction database, and
the jurisdiction database is a database in which regions and jurisdictions to which the regions belong are registered in association with each other.

20. A window generation program that sends an instruction to a client terminal and causes the client terminal to execute:
determining, based on a location of a client terminal that accesses a web page, a jurisdiction to which the location of the client terminal belongs;
generating a window corresponding to the jurisdiction; and
causing the window to be displayed on the client terminal, wherein the window is displayed on a display of the client terminal when a request specifying a URL of the web page is sent from the client terminal to a server.
